(19) United States
(12) Patent Application Publication
(10) Pub. No.: US 2020/0273605 A1
(43) Pub. Date: Aug. 27, 2020

(54) UTP CABLE AND CONNECTOR

(71) Applicants: AutoNetworks Technologies, Ltd., Mie (JP); Sumitomo Wiring Systems, Ltd., Mie (JP); Sumitomo Electric Industries, Ltd., Osaka (JP)

(72) Inventor: Keigo Takahashi, Mie (JP)

(21) Appl. No.: 16/754,205

(22) PCT Filed: Oct. 10, 2018
(86) PCT No.: PCT/JP2018/037659

§ 371 Date: Apr. 7, 2020

(30) Foreign Application Priority Data
Oct. 20, 2017 (JP) 2017-203246

(51) Int. Cl. H01B 11/02; H01B 7/22; H01R 13/6463; H01B 3/30

(52) U.S. Cl. CPC H01B 11/02; H01B 3/30; H01R 13/6463; H01B 7/22

(57) ABSTRACT

A UTP cable 10 includes two core wires 11 that are twisted together, an inner jacket 12 disposed on the outer side of the two core wires 11, and an outer jacket 13 disposed on the outer side of the inner jacket 12, and a separation region 17 where the outer surface of the inner jacket 12 and the inner surface of the outer jacket 13 are separated from each other is provided between the inner jacket 12 and the outer jacket 13.

### TECHNICAL FIELD

Techniques disclosed in this specification relate to a UTP cable and a connector provided with the same.

### BACKGROUND

UTP (Unshielded Twisted-Pair) cables are usually obtained by twisting together two core wires, each of which being obtained by covering an outer circumferential surface of a conductor with an insulating synthetic resin, and disposing a jacket on the outer side of the two core wires that are twisted together.

A connector is connected to a terminal end of the UTP cable. In order to connect a connector, the jacket is stripped at the terminal end of the UTP cable, and the two core wires are untwisted. Also, a terminal is connected to the conductor exposed due to coatings of the core wires being stripped. This terminal is housed in a connector housing of the connector. JP 2004-71404A is known as such a UTP cable.

### PRIOR ART DOCUMENT

### Patent Document

Patent Document 1: JP 2004-71404A

### SUMMARY OF THE INVENTION

### Problems to be Solved

The untwisting length of the two core wires is as short as possible from the viewpoint of transmission characteristics. Thus, there are cases where a connector in which untwisted portions of the two core wires are disposed in the connector housing is used. The terminal end of the jacket of the UTP cable is also inserted into the connector housing of such a connector.

There is a possibility that the transmission characteristics of an in-vehicle UTP cable will deteriorate due to influences of a surrounding environment, such as water intrusion, and thus a separation distance between the two core wires and the peripheries thereof can be secured by adjusting the thickness of the jacket.

However, if the jacket is thickened in order to suppress deterioration of the transmission characteristics, for example, there is a risk that the jacket cannot be inserted into an existing connector housing. In recent years, there is demand for reducing the space for routing cables, following an increase in living spaces, and thus it is not practical to increase the size of a connector so as to be able to accept a UTP cable with a thick jacket.

Techniques disclosed in this specification have been accomplished based on the above-described circumstances, and aim to provide a UTP cable for which an increase in the size of a connector is suppressed while deterioration of transmission characteristics thereof is suppressed.

### Means to Solve the Problem

A technique disclosed in this specification is a UTP cable, the UTP cable including two core wires that are twisted together, an inner jacket disposed on an outer side of the two core wires, and an outer jacket disposed on an outer side of the inner jacket, in which a separation region where an inner surface of the inner jacket and an outer surface of the outer jacket are separated from each other is provided between the inner jacket and the outer jacket.

Also, a technique disclosed in this specification is a connector, the connector including a terminal connected to a terminal end of the UTP cable and a connector housing that houses the terminal and into which the inner jacket exposed at the terminal end of the UTP cable is inserted.

According to the above-described configuration, deterioration of the transmission characteristics of the UTP cable can be suppressed by thickening the outer jacket, without changing the thickness of the inner jacket.

Also, according to the above-described configuration, because the inner jacket and the outer jacket are not in direct contact with each other in the separation region, the outer jacket can be easily stripped at the terminal end of the UTP cable, while leaving the inner jacket. This allows a configuration for inserting the inner jacket whose outer diameter is smaller than that of the outer jacket into the connector housing, thus suppressing an increase in the size of the connector.

The following aspects are preferable as embodiments of the techniques disclosed in this specification.

It is preferable that an interposing object is disposed between the inner jacket and the outer jacket.

According to the above-described configuration, a separation region can be reliably provided by the interposing object between the inner jacket and the outer jacket, and thus the outer jacket can be more easily stripped at the terminal end of the UTP cable. This makes it possible to improve the efficiency of an operation for stripping the UTP cable.

The interposing object is preferably tape wound on an outer surface of the inner jacket.

According to the above-described configuration, it is possible to dispose the interposing object between the inner jacket and the outer jacket using a simple method for winding tape on the outer surface of the inner jacket.

The tape preferably contains ferrite.

According to the above-described configuration, it is possible to reduce noise that may be mixed in the core wires.

It is preferable that at least one of an inner surface and an outer surface of the tape contains metal.

According to the above-described configuration, it is possible to further reduce a frictional force between the inner jacket and the outer jacket, compared to a case where the inner jacket and the outer jacket are in direct contact with each other. This makes it possible to improve the efficiency of an operation for stripping the UTP cable.

It is preferable that the interposing object is a linear member disposed on an outer surface of the inner jacket in a direction in which the inner jacket extends.

According to the above-described configuration, the stripped outer jacket can easily move along the linear member in the direction in which the inner jacket extends, due to the stripped outer jacket sliding against the linear member. This makes it possible to improve the efficiency of an operation for stripping the UTP cable.

It is preferable that an outer surface of the inner jacket is provided with a protrusion.

According to the above-described configuration, the separation region can be reliably provided between the inner jacket and the outer jacket by the protrusion provided on the outer surface of the inner jacket, and thus it is possible to improve the efficiency of an operation for stripping the UTP cable.

### Effect of the Invention

According to the techniques disclosed in this specification, it is possible to suppress an increase in the size of a connector while suppressing deterioration of transmission characteristics thereof.

### BRIEF DESCRIPTION OF THE DRAWINGS

FIG. 1 is a perspective view showing a UTP cable according to Embodiment 1.

FIG. 2 is a cross-sectional view showing the UTP cable.

FIG. 3 is a cross-sectional view showing a connector.

FIG. 4 is a partially enlarged cross-sectional view showing the connector according to FIG. 4.

FIG. 5 is a perspective view showing a UTP cable according to Embodiment 2.

FIG. 6 is a cross-sectional view showing the UTP cable.

FIG. 7 is a cross-sectional view showing a connector.

FIG. 8 is a cross-sectional view showing a UTP cable according to Embodiment 3.

### DETAILED DESCRIPTION TO EXECUTE THE INVENTION

### EMBODIMENT 1

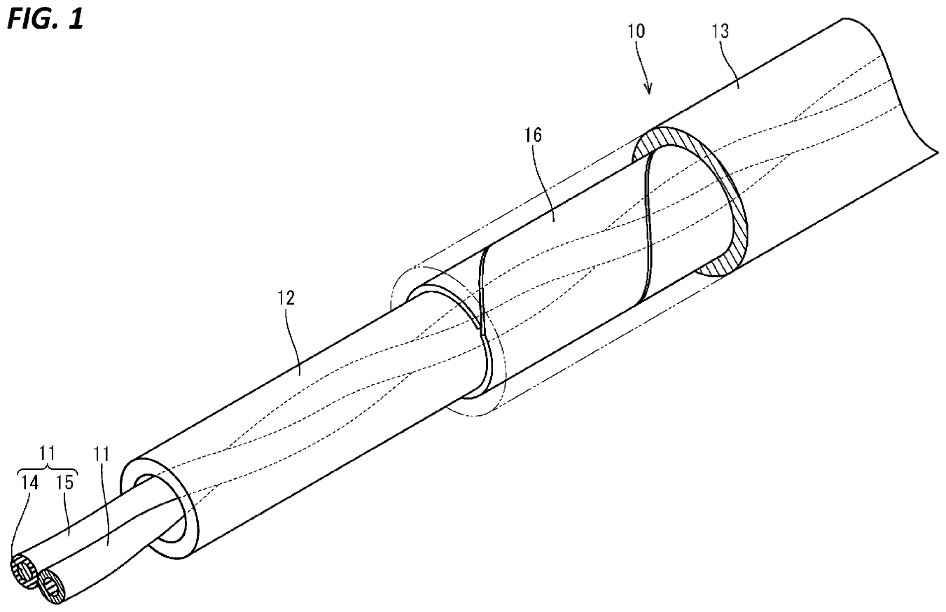

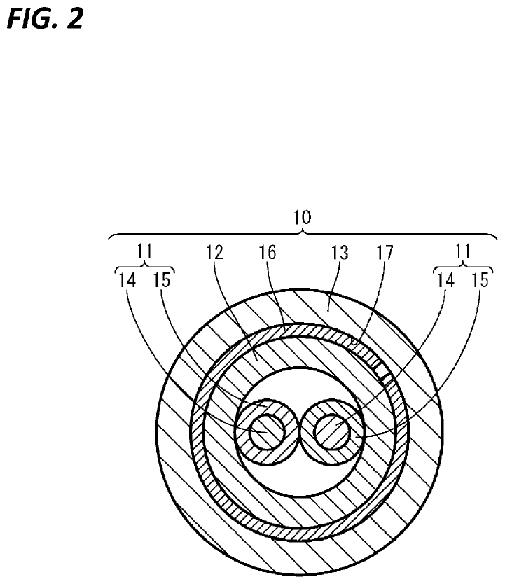

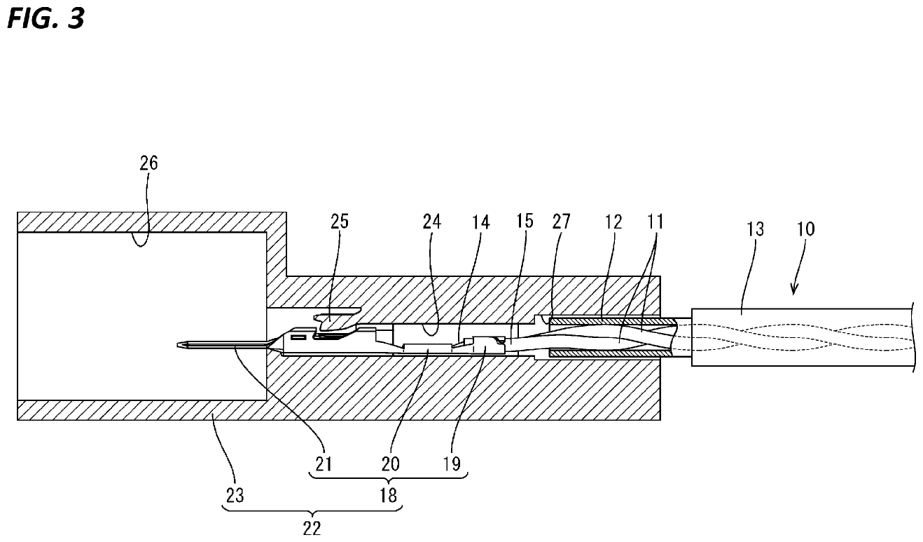

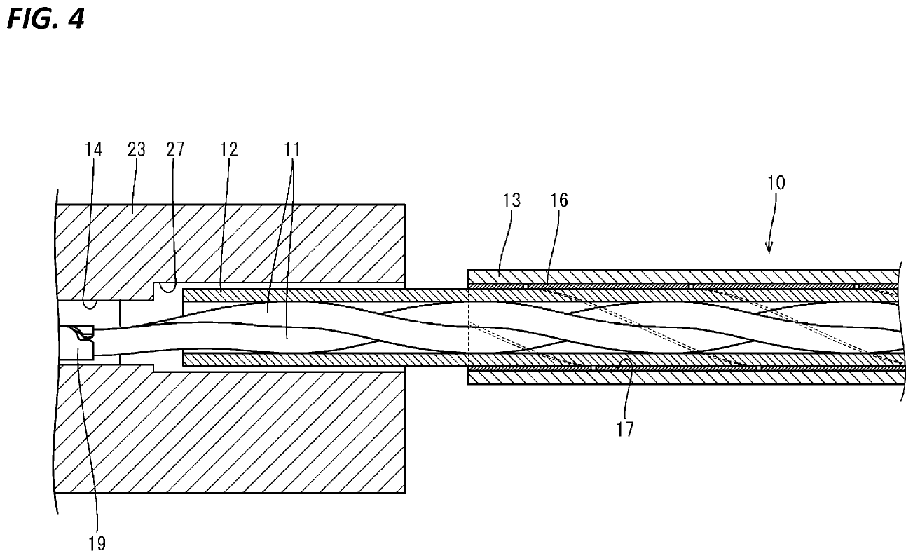

Embodiment 1 of the techniques disclosed in this specification will be described with reference to FIGS. 1 to 4. A UTP cable 10 according to this embodiment includes two core wires 11, an inner jacket 12, and an outer jacket 13. Note that, with regard to a plurality of the same members, some of the same members may be given reference numerals, and the other members may not be given reference numerals.

The core wires 11 each include a conductor 14 made of metal, and an insulating coating 15 that covers an outer circumferential surface of the conductor 14 and is made of an insulating synthetic resin. The two core wires 11 are twisted together. The cross-sectional shape of the core wire 11 is a circular shape.

The inner jacket 12 made of an insulating synthetic resin is disposed on the outer side of the twisted two core wires 11. The inner jacket 12 has a cylindrical shape.

Tape 16 (one example of an interposing object) is wound on the outer surface of the inner jacket 12. The tape 16 is helically wound on the outer surface of the inner jacket 12. The tape 16 may be configured to be wound thereon without a gap as a result of side edges thereof overlapping each other, or may be configured to be wound thereon with a gap between the side edges thereof. In other words, the tape 16 may be wound thereon such that the outer surface of the inner jacket 12 is not exposed, or may be wound thereon such that a portion of the outer surface of the inner jacket 12 is exposed.

The tape 16 functions as an interposing object disposed between the inner jacket 12 and the outer jacket 13. Accordingly, the outer surface of the inner jacket 12 and the inner surface of the outer jacket 13 are separated from each other only by at least the thickness of the tape 16. In this embodiment, a region where the tape 16 is interposed between the inner jacket 12 and the outer jacket 13 indicates a separation region 17 where the outer surface of the inner jacket 12 and the outer surface of the outer jacket 13 are separated from each other. Also, even in the case of a region where no tape 16 is disposed between the inner jacket 12 and the outer jacket 13, a region where the outer surface of the inner jacket 12 and the outer surface of the outer jacket 13 are separated from each other indicates the separation region 17.

The tape 16 is flexible and has an elongated tape shape, and contains ferrite. As the tape 16, a configuration may be adopted in which ferrite is applied to a surface of a film made of a synthetic resin, or any configuration may be adopted as needed. An adhesive may be applied to a surface of the tape 16 located on the inner jacket 12 side, or an adhesive may not to be applied thereto. Note that no adhesive is applied to a surface of the tape 16 located on the outer jacket 13 side.

The outer jacket 13 is disposed outward in the radial direction of the inner jacket 12, and on the outer side of the tape 16. The outer jacket 13 is made of an insulating synthetic resin. The outer jacket 13 has a cylindrical shape.

Because no adhesive is applied to the outer surface of the tape 16, friction is relatively low between the outer surface of the tape 16 and the inner surface of the outer jacket 13.

The outer jacket 13 is stripped at the terminal end of the UTP cable 10. Accordingly, a predetermined length of the inner jacket 12 is exposed. The tape 16 is also peeled off from the outer surface of the inner jacket 12 in a portion where the outer jacket 13 is stripped.

Also, the terminal end of the inner jacket 12 is stripped, and the two core wires 11 are exposed. The conductors 14 are exposed due to the insulating coatings 15 being stripped at the terminal ends of the core wires 11. The terminal 18 is connected to the terminal ends of the conductors 14.

The terminal 18 includes an insulation barrel 19 to be crimped to the outer circumferential surfaces of the insulating coatings 15 of the core wires 11, a wire barrel 20 that is continuous with the insulation barrel 19 and is to be crimped to the outer circumferential surfaces of the conductors 14 of the core wires 11, and a connection portion 21 that is continuous with the wire barrel 20 and is connected to a counterpart terminal (not shown). The terminal 18 according to this embodiment is a male terminal whose connection portion 21 has a tab shape.

A connector 22 is attached to the end portion of the UTP cable 10. The connector 22 includes the terminal 18 connected to the terminal end of the UTP cable 10, and the connector housing 23 made of an insulating synthetic resin. The connector housing 23 has a cavity 24 for housing the terminal 18. A lance 25 that is locked to the terminal 18 and keeps the terminal 18 in the cavity 24 is formed in the cavity 24. As a result of the lance 25 elastically engaging with the terminal 18 from a rear side, the terminal 18 is prevented from coming loose rearward.

The connection portion 21 of the terminal 18 having a tab shape is disposed in the connector housing 23, and a hood portion 26 to which a counterpart connector (not shown) is fitted is open in the connector housing 23.

A jacket insertion portion 27 into which an end portion of the inner jacket 12 is inserted is open rearward of the connector housing 23 and is located rearward of the cavity 24. The inner diameter of the jacket insertion portion 27 is set to be the same as or larger than the outer diameter of the inner jacket 12. Accordingly, the inner jacket 12 can be inserted into the jacket insertion portion 27.

Next, one example of a process for attaching the UTP cable 10 according to this embodiment to the connector 22 will be described. Note that the process for attaching the UTP cable 10 to the connector 22 is not limited to the description below.

A notch is provided using a cutter (not shown) at a position located only a predetermined length away from an end portion of the outer jacket 13 of the UTP cable 10. The outer jacket 13 is pulled out from the portion provided with the notch toward the terminal end of the UTP cable 10. At this time, because the tape 16 is disposed between the outer jacket 13 and the inner jacket 12, the inner surface of the outer jacket 13 and the outer surface of the inner jacket 12 are separated from each other. This allows the outer jacket 13 to easily separate from the inner jacket 12. Also, because no adhesive is applied to the surface of the tape 16 located on the outer jacket 13 side, friction between the surface of the tape 16 and the inner surface of the outer jacket 13 is further reduced. This makes it possible to easily strip the outer jacket 13.

After the outer jacket 13 is stripped, the tape 16 wound on the outer surface of the inner jacket 12 is peeled off. Then, a notch is provided using a cutter (not shown) at a position located only a predetermined length away from an end portion of the inner jacket 12. The inner jacket 12 is pulled out from the portion provided with the notch toward the terminal end of the UTP cable 10. Accordingly, the two core wires 11 are exposed.

The two core wires 11 exposed from the end portion of the inner jacket 12 are untwisted. The insulating coating 15 is stripped from each of the untwisted core wires 11. Accordingly, the conductors 14 of the core wires 11 are exposed.

The wire barrel 20 is crimped to the core wires exposed from the insulating coatings 15, and the insulation barrel 19 is crimped to the insulating coatings 15. Accordingly, the terminal 18 is connected to the two core wires 11.

The terminal 18 is inserted from the rear side into the jacket insertion portion 27 of the connector housing 23 and pushed into the cavity 24. As a result of the connection portion 21 of the terminal 18 reaching the inside of the hood portion 26, and the lance 25 being elastically locked to the terminal 18, the terminal 18 is kept in the cavity 24. A leading end portion of the inner jacket 12 is inserted into a jacket insertion hole in this state. The outer jacket 13 is disposed at a position located rearward of the connector housing 23, and is not inserted into the jacket insertion portion 27. Accordingly, the connector 22 is complete.

Next, effects of this embodiment will be described. The UTP cable 10 according to this embodiment includes the two core wires 11 that are twisted together, the inner jacket 12 disposed on the outer side of the two core wires 11, and the outer jacket 13 disposed on the outer side of the inner jacket 12, and the separation region 17 where the inner surface of the inner jacket 12 and the outer surface of the outer jacket 13 are separated from each other is provided between the inner jacket 12 and the outer jacket 13.

Also, the connector 22 according to this embodiment includes the terminal 18 connected to the terminal end of the UTP cable 10, and the connector housing 23 that houses the terminal 18 and into which the inner jacket 12 exposed at the terminal end of the UTP cable 10 is inserted.

According to the above-described configuration, deterioration of the transmission characteristics of the UTP cable 10 can be suppressed by thickening the outer jacket 13 without changing the thickness of the inner jacket 12.

Also, according to the above-described configuration, because the inner jacket 12 and the outer jacket 13 are separated from each other in the separation region 17, it is possible to easily strip the outer jacket 13 while leaving the inner jacket 12, at the terminal end of the UTP cable 10. This allows a configuration for inserting the inner jacket 12 whose outer diameter is smaller than that of the outer jacket 13 into the connector housing 23, thus suppressing an increase in the size of the connector 22.

Also, according to this embodiment, the tape 16 is disposed between the inner jacket 12 and the outer jacket 13.

According to the above-described configuration, the separation region 17 can be reliably provided by the tape 16 between the inner jacket 12 and the outer jacket 13, and thus the outer jacket 13 can be more easily stripped at the terminal end of the UTP cable 10. This makes it possible to improve the efficiency of an operation for stripping the UTP cable 10.

Also, according to the above-described configuration, the tape 16 containing ferrite is wound around the two core wires 11. Accordingly, high-frequency noise can be attenuated by the tape 16. Also, a magnetic flux is generated in the ferrite included in the tape 16 due to an electric current flowing through the core wires 11, and energy of the electric current is changed to magnetic energy, and the magnetic flux is converted back to an electric current through electromagnetic induction, following the change in the electric current. At this time, because part of the energy of the magnetic flux is lost as magnetic loss, part of the noise current that has passed through the core wires 11 is lost as magnetic loss. Accordingly, it is possible to reduce the noise of signals flowing through the core wires 11.

### VARIATIONS

Next, a variation of Embodiment 1 will be described. Although a configuration is adopted in which the tape 16 containing ferrite is wound on the outer circumferential surface of the inner jacket 12 in the above-described embodiment, there is no limitation thereto, and the tape 16 may be made of metal. A metal having a configuration resulting from a conductive metal such as copper, a copper alloy, aluminum, or an aluminum alloy being thinly spread can be used as the metal constituting the tape 16.

Also, it is possible to use, as the tape 16, tape having a configuration resulting from metal powder being applied to at least one of the inner surface and the outer surface of the tape 16 made of a synthetic resin such as polyethylene, polypropylene, polyethylene terephthalate, polybutylene terephthalate, or nylon 6, 6. Metal powder may be applied to both surfaces of the tape 16. Conductive metal powder such as copper powder, copper alloy powder, aluminum powder, or aluminum alloy powder can be used as the above-described metal powder.

According to the above-described configuration, because at least one of the inner surface and the outer surface of the tape 16 contains metal, it is possible to further reduce a frictional force between the inner jacket 12 and the outer jacket 13, compared to a case where the inner jacket 12 and the outer jacket 13 are in direct contact with each other. This makes it possible to improve the efficiency of an operation for stripping the outer jacket 13.

It is preferable that the tape 16 according to this variation is wound on the outer surface of the inner jacket 12 without a gap because a frictional force with the outer jacket 13 can be further reduced.

### EMBODIMENT 2

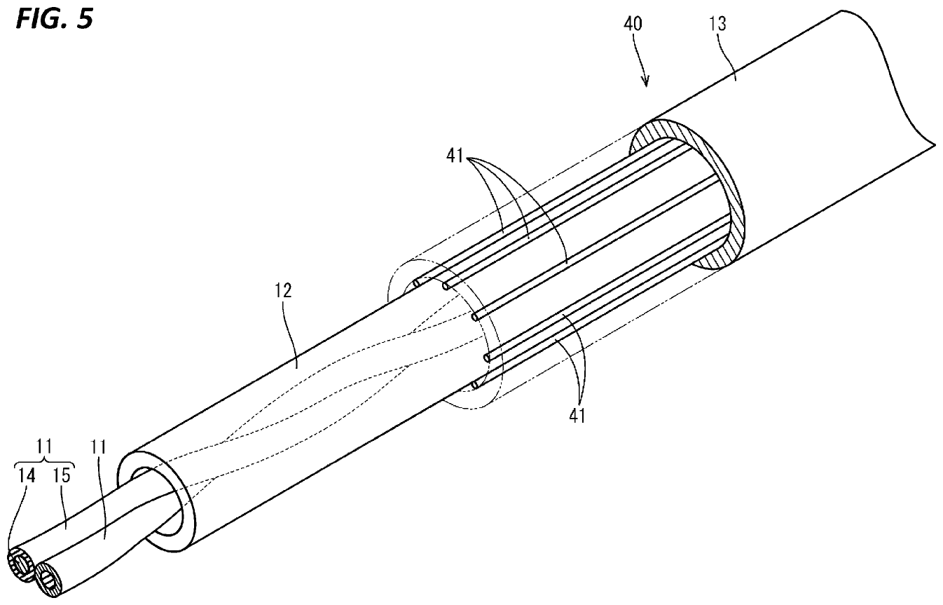

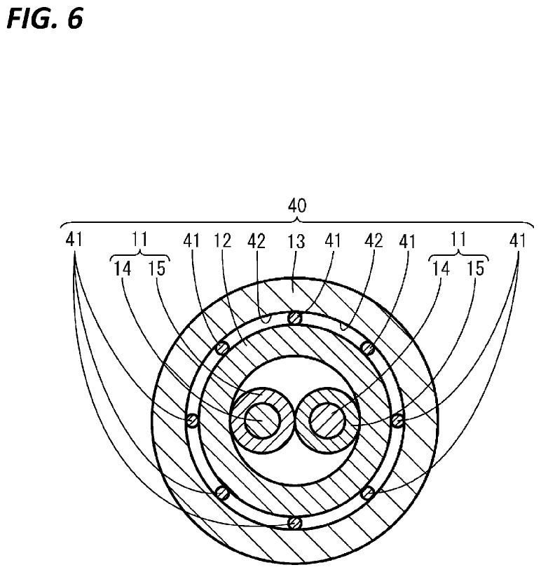

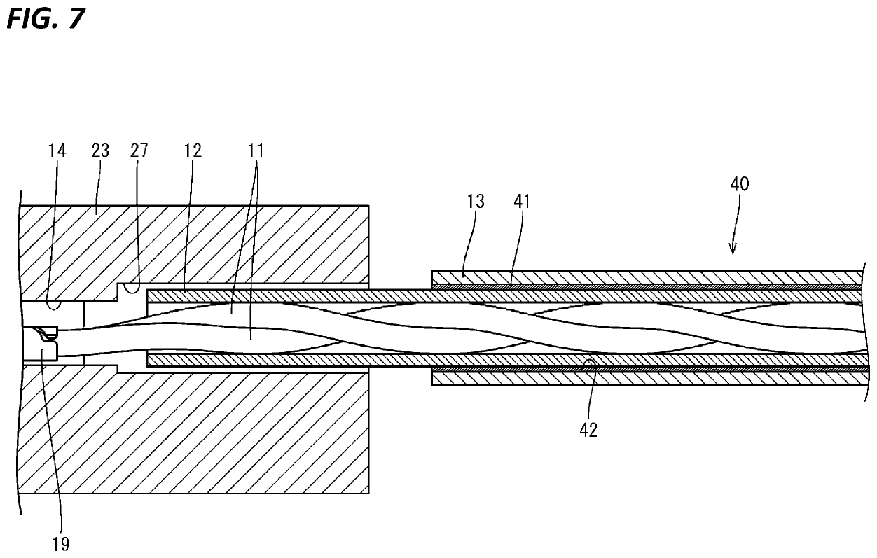

Next, Embodiment 2 of the techniques disclosed in this specification will be described with reference to FIGS. 5 to 7.

In a UTP cable 40 according to this embodiment, a plurality (eight in this embodiment) of linear members 41 (one example of an interposing object) are disposed side-by-side and spaced apart from each other in the circumferential direction of the inner jacket 12 between the inner jacket 12 and the outer jacket 13. The linear members 41 are disposed extending in the direction in which the UTP cable 40 extends. Intervals between the linear members 41 are substantially equal intervals in the circumferential direction of the inner jacket 12. The cross-section of each linear member 41 has a circular shape. Diameters of the linear members 41 are substantially equal to each other.

Any material such as metal or synthetic resin can be selected as appropriate as the material of the linear members 41. The cross-sectional shape of the linear members 41 is not limited to a circular shape, and may be an elliptic shape, an oval shape, or a polygonal shape such as a triangular shape or a quadrangular shape. Also, intervals between the linear members 41 in the circumferential direction of the inner jacket 12 are not limited to equal intervals, and the linear members 41 may be disposed at different intervals.

The outer surface of the inner jacket 12 and the inner surface of the outer jacket 13 are separated from each other only by at least the diameter of the linear members 41 due to the linear members 41 being interposed therebetween. Accordingly, in a region located between the inner jacket 12 and the outer jacket 13, portions where at least the linear members 41 are disposed indicate separation regions 42 where the inner surface of the inner jacket 12 and the outer surface of the outer jacket 13 are separated from each other. Also, in portions where no linear members 41 are disposed, regions where the outer surface of the inner jacket 12 and the inner surface of the outer jacket 13 are separated from each other also indicate the separation regions 42.

Because configurations other than the above are substantially the same as that of Embodiment 1, the same members are given the same reference numerals, and a redundant description will be omitted.

According to this embodiment, the linear members 41 disposed in the direction in which the inner jacket 12 extends are disposed on the outer surface of the inner jacket 12. Accordingly, the stripped outer jacket 13 can easily move along the linear members 41 in the direction in which the inner jacket 12 extends, due to the stripped outer jacket 13 sliding against the linear members 41. As a result, it is possible to improve the efficiency of an operation for stripping the UTP cable 40.

### EMBODIMENT 3

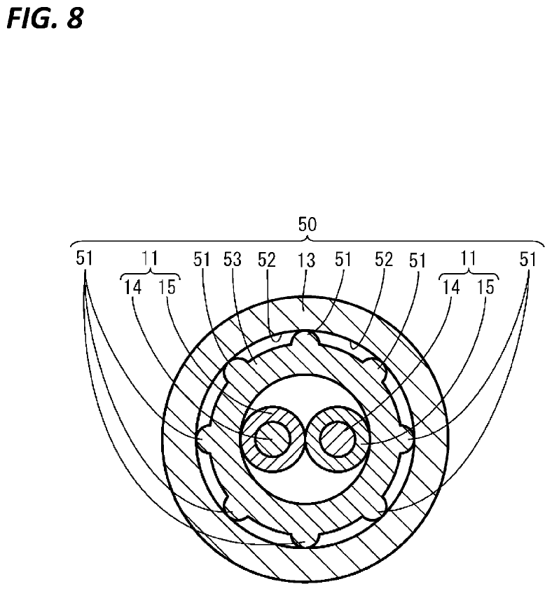

Next, Embodiment 3 of the techniques disclosed in this specification will be described with reference to FIG. 8. In a UTP cable 50 according to this embodiment, a plurality (eight in this embodiment) of protrusions 51 protruding outward in the longitudinal and latitudinal direction of the UTP cable 10 are formed on the outer surface of an inner jacket 53. The protrusions 51 are formed extending in the direction in which the inner jacket 53 extends, and each have a substantially rib-shape. The protrusions 51 are formed side-by-side at substantially equal intervals in the circumferential direction of the inner jacket 53. Sizes of the protrusions 51 that protrude from the outer surface of the inner jacket 53 are set to be substantially the same. The cross-sectional shape of each protrusion 51 is a substantially semicircular shape.

The cross-sectional shape of the protrusions 51 is not limited to a circular shape, and may be an elliptic shape, an oval shape, or a polygonal shape such as a triangular shape or a quadrangular shape. Also, intervals between the protrusions 51 in the circumferential direction of the inner jacket 53 are not limited to equal intervals, and the protrusions 51 may be disposed at different intervals.

The outer surface of the inner jacket 53 and the inner surface of the outer jacket 13 are separated from each other only by the size of the protrusions 51 that protrude from the outer surface of the inner jacket 53, due to the protrusions 51 being interposed therebetween. Because leading ends of the protrusions 51 and the inner surface of the outer jacket 13 are in contact with each other, in this embodiment, regions where the leading ends of the protrusions 51 and the inner surface of the outer jacket 13 are not in contact with each other, and where the inner surface of the inner jacket 53 and the outer surface of the outer jacket 13 are separated from each other indicate separation regions 52. Note that portions of the inner jacket 53 other than the protrusions 51 may be in contact with the inner surface of the outer jacket 13.

Because configurations other than the above are substantially the same as that of Embodiment 1, the same members are given the same reference numerals, and a redundant description will be omitted.

According to this embodiment, the outer surface of the inner jacket 53 is provided with the protrusions 51. Because the separation regions 52 can be reliably provided between the inner jacket 53 and the outer jacket 13 by the protrusions 51 provided on the outer surface of the inner jacket 53, it is possible to improve the efficiency of an operation for stripping the UTP cable 50.

### OTHER EMBODIMENTS

The techniques disclosed in this specification are not limited to the embodiments described above using the foregoing description and drawings, and embodiments such as the following are also encompassed in the technical scope of the techniques disclosed in this specification.

(1) Although the interposing object according to Embodiment 1 has a tape shape and the interposing object according to Embodiment 2 is the linear member 41, there is no limitation on the shape of the interposing object, and any shape such as a sheet shape or a thread shape can be selected as appropriate. Also, the interposing object may be omitted.

(2) Although the tape 16 containing ferrite is used as the interposing object in Embodiment 1, the tape 16 may be made of a synthetic resin. Also, an adhesive may be applied to a surface of the tape 16 located on the outer jacket 13 side.

(3) Although eight linear members 41 are used in Embodiment 2, there is no limitation thereto, and the number of linear members 41 may be 1, 2 to 7, or 9 or more. Also, the linear member 41 may be made of metal or ferrite. If the linear member 41 is made of ferrite, it is possible to reduce noise that may be mixed in the core wires 11.

(4) Although a configuration is adopted in which eight protrusions 51 protrude from the inner jacket 53 in Embodiment 3, the number of protrusions 51 may be 1, 2 to 7, or 9 or more. The inner surface of the outer jacket 13 may be provided with the protrusions 51.

(5) Although a configuration is adopted in which no interposing object is disposed between the inner jacket 53 and the outer jacket 13 in Embodiment 3, there is no limitation thereto, and a configuration may be adopted in which an interposing object is disposed in a region where the leading ends of the protrusions 51 and the inner surface of the outer jacket 13 are not in contact with each other, the region being located between the inner jacket 53 and the outer jacket 13.

(6) Although the terminal 18 is a male terminal in Embodiments 1 to 3, there is no limitation thereto, and the terminal may be a female terminal.

### LIST OF REFERENCE NUMERALS

10, 40, 50 UTP cable

11 Core wire

12 Inner jacket

13 Outer jacket

16 Tape

17, 42, 52 Separation region

18 Terminal

22 Connector

23 Connector housing

41 Linear member

51 Protrusion

1. A UTP cable comprising:
two core wires that are twisted together;
an inner jacket disposed on an outer side of the two core wires; and
an outer jacket disposed on an outer side of the inner jacket,
wherein a separation region where an outer surface of the inner jacket and an inner surface of the outer jacket are separated from each other is provided between the inner jacket and the outer jacket,
an interposing object is disposed between the inner jacket and the outer jacket, and
the interposing object is a plurality of linear members that are disposed on the outer surface of the inner jacket in a direction in which the inner jacket extends, and are arranged side-by-side and spaced apart from each other in a circumferential direction of the inner jacket.

2-6. (canceled)

7. A UTP cable comprising:
two core wires that are twisted together;
an inner jacket disposed on an outer side of the two core wires; and
an outer jacket disposed on an outer side of the inner jacket,
wherein a separation region where an outer surface of the inner jacket and an inner surface of the outer jacket are separated from each other is provided between the inner jacket and the outer jacket, and
the outer surface of the inner jacket is provided with a protrusion.

8. A connector comprising:
a terminal connected to a terminal end of the UTP cable according to claim 1; and
a connector housing that houses the terminal and into which the inner jacket exposed at the terminal end of the UTP cable is inserted.
